(19) United States
(12) Patent Application Publication
(10) Pub. No.: US 2007/0160793 A1
(43) Pub. Date: Jul. 12, 2007

(54) Load-bearing composite panels

(75) Inventors: Ronald A. Cageao, Beaver, PA (US); Don R. Shomer, Lake Orion, MI (US); Jeremy A. Panasiewicz, Macomb Township, MI (US); Gerard R. Olszewski, Temperance, MI (US)

Correspondence Address: BAYER MATERIAL SCIENCE LLC, 100 BAYER ROAD, PITTSBURGH, PA, 15205, US

(73) Assignee: Bayer MaterialScience LLC and DaimlerChrysler Corporation

(21) Appl. No.: 11/313,416

(22) Filed: Dec. 21, 2005

(51) Int. Cl. B32B 1/08; B29C 47/00

(52) U.S. Cl. 428/36.9; 428/116

(57) ABSTRACT

The present invention provides load-bearing composite panels made by surrounding with a long fiber reinforced polyurethane an assembly containing one or more load-bearing members and a structural polyurethane sandwich composite. The inventive load-bearing composite panels may help provide stronger, lighter weight structural items such as vehicle floor panels, walls for mobile homes, roof modules, truck beds, truck trailer floors and the like.

### FIELD OF THE INVENTION

The present invention relates, in general to vehicle construction, and more specifically to load-bearing composite panels made by surrounding with a long fiber reinforced polyurethane an assembly made from one or more load-bearing members and a structural polyurethane sandwich composite.

### BACKGROUND OF THE INVENTION

Vehicle panels oftentimes must endure a variety of structural stresses caused by the vehicle's movement over streets, highways and uneven terrain. One desirable quality of these panels is light weight to improve the vehicle's fuel efficiency. However, this lighter weight can, and frequently does, militate against the strength necessary to tolerate the structural stresses encountered. A number of workers have attempted to provide vehicle panels which can meet the frequently competing attributes of structural strength and light weight.

For example, Jaggi, in U.S. Pat. No. 6,854,791, teaches a vehicle cell made of reinforced thermoplastic material which includes a shape-defining, long-fiber-reinforced thermoplastic matrix with integrated continuous fiber strands or strips. A base structure includes a base plate, uninterrupted continuous fiber strands running longitudinally in an upper base area and continuous fiber strands running longitudinally in a lower base area. The upper and the lower base areas are connected with vertical walls. Although teaching the use of thermoplastic materials, the disclosure of Jaggi makes no mention of using thermosetting materials.

U.S. Pat. No. 6,299,246, issued to Tomka, discloses a plastic molding and design structure that has a load-bearing structure, which is wholly or partly surrounded by a polymer material forming the molding. The load-bearing structure of Tomka is formed from several interconnected, high strength, continuous fiber-reinforced structural elements. Tomka states that his invention makes it possible, to produce structures with the most varied shapes such as containers, tanks, vehicle frames, etc. in a simple and inexpensive manner. It should be noted that Tomka only teaches the use of continuous fibers.

U.S. Pat. No. 4,405,752, issued to Recker, et al., provides a process for the production of fiber-reinforced molded products, involving combining two specific isocyanates and specific isocyanate-reactive components and adding a fiber material having a fiber length of from 10 to 100 mm. Recker, et al., in U.S. Pat. No. 4,336,180, teach a substantially solvent-free molding material which is obtained from a prepolymer and 5 to 69% by weight of an organic or inorganic fibrous material with a fiber length of from 0.1 to 100 mm. Neither Recker, et al. patent teaches the use of load-bearing members.

As these materials exhibit some drawbacks, a need persists in the art for strong, yet lightweight load-bearing panels which are suitable for inclusion in vehicles.

### SUMMARY OF THE INVENTION

Accordingly, the present invention provides such a panel and a process for its production. The inventive load-bearing composite panel is made by surrounding with a long fiber reinforced polyurethane an assembly made from one or more load-bearing members and a structural polyurethane sandwich composite. The lightweight inventive panels have greater bending and buckling strength than the sum of the individual components due to the physical properties of the long fiber reinforced polyurethane. The inventive composite panels may find use in such items as automobile floor panels, walls for mobile homes, roof modules, truck beds, truck trailer floors and the like.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows a cross-section taken through an embodiment of the load-bearing composite panel of the present invention;

FIG. 2 depicts a cross section taken through another embodiment of the load-bearing composite panel of the present invention;

FIG. 3 illustrates a cross section taken through an embodiment of the load-bearing composite panel of the present invention having two load-bearing members and which is mounted in brackets; and

FIG. 4 shows a cross section taken though an embodiment of the load-bearing composite panel of the present invention which contains a metal stamping as a load bearing member.

### DETAILED DESCRIPTION OF THE INVENTION

The present invention will now be described for purposes of illustration and not limitation. Except in the operating examples, or where otherwise indicated, all numbers expressing quantities, percentages and so forth in the specification are to be understood as being modified in all instances by the term “about.”

The present invention provides a load-bearing composite panel made from a long fiber reinforced polyurethane surrounding an assembly made from one or more load-bearing members and a structural polyurethane sandwich composite.

The present invention further provides a process for making a load-bearing composite panel involving surrounding with a long fiber reinforced polyurethane an assembly made from one or more load-bearing members and a structural polyurethane sandwich composite.

As load-bearing members may be mentioned natural (e.g., wood), synthetic (e.g., polyurethane and other plastics) and metal (e.g., steel and aluminum) tubes, rods, beams, slabs, plates, planks and stampings. The load-bearing members may be hollow or solid.

The structural polyurethane sandwich composite may encase or abut (contact) these load-bearing member(s) as the panel's intended use may necessitate. Structural polyurethane sandwich composites may be made from one or more glass fiber mats, a rigid or flexible polyurethane foam and a paper honeycomb.

As those skilled in the art are aware, long fiber reinforced polyurethane contains reinforcing fibers whose nature is such as to prevent the use of a conventional high pressure mixing head. The long fibers may be introduced into the polyurethane by means, for example, of chopped fiber injection (“CFI”) techniques, known to those skilled in the art. CFI machines and processes are available from a number of suppliers including Krauss-Maffei (LFI-PUR), The Cannon Group (InterWet) and Hennecke GmbH (FipurTec).

The long fibers useful in the present invention are preferably more than 3 mm, more preferably more than 10 mm, and most preferably from 12 mm to 75 mm in length. Where appropriate it is also possible to introduce the long fibers in the form of mats into the polyurethane. Examples of suitable types of long fibers for use in the present invention include, but are not limited to, glass fibers; natural fibers, such as those of flax, jute or sisal; and synthetic fibers, such as polyamide fibers, polyester fibers, carbon fibers and polyurethane fibers. Glass fibers are particularly preferred as long fibers in the present invention.

The long fibers preferably make up from 5 to 75 wt. %, more preferably from 10 to 60 wt. %, and most preferably from 20 to 50 wt. % of the long fiber-reinforced polyurethane. The long fibers may be present in the long fiber-reinforced polyurethane of the inventive load-bearing composite panel in an amount ranging between any combination of these values, inclusive of the recited values.

As those skilled in the art are aware, polyurethanes are the reaction products of polyisocyanates with isocyanate-reactive compounds, optionally in the presence of blowing agents, catalysts, auxiliaries and additives.

Suitable as isocyanates for the long fiber reinforced polyurethane and the second polyurethane of the composite panel of the present invention include unmodified isocyanates, modified polyisocyanates, and isocyanate prepolymers. Such organic polyisocyanates include aliphatic, cycloaliphatic, araliphatic, aromatic, and heterocyclic polyisocyanates of the type described, for example, by W. Siefken in Justus Liebigs Annalen der Chemie, 562, pages 75 to 136. Examples of such isocyanates include those represented by the formula
Q(NCO)ₙ
in which n is a number from 2-5, preferably 2-3, and Q is an aliphatic hydrocarbon group containing 2-18, preferably 6-10, carbon atoms; a cycloaliphatic hydrocarbon group containing 4-15, preferably 5-10, carbon atoms; an araliphatic hydrocarbon group containing 8-15, preferably 8-13, carbon atoms; or an aromatic hydrocarbon group containing 6-15, preferably 6-13, carbon atoms.

Examples of suitable isocyanates include ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; 1-isocyanato-3,3,5-trimethyl-5-isocyanatomethylcyclohexane (isophorone diisocyanate; e.g., German Auslegeschrift 1,202,785 and U.S. Pat. No. 3,401,190); 2,4- and 2,6-hexahydrotoluene diisocyanate and mixtures of these isomers; dicyclohexylmethane-4,4′-diisocyanate (hydrogenated MDI, or HMDI); 1,3- and 1,4-phenylene diisocyanate; 2,4- and 2,6-toluene diisocyanate and mixtures of these isomers (TDI); diphenylmethane-2,4′- and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MDI), which are described, for example, in GB 878,430 and GB 848,671; norbornane diisocyanates, such as described in U.S. Pat. No. 3,492,330; m- and p-isocyanatophenyl sulfonylisocyanates of the type described in U.S. Pat. No. 3,454,606; perchlorinated aryl polyisocyanates of the type described, for example, in U.S. Pat. No. 3,227,138; modified polyisocyanates containing carbodiimide groups of the type described in U.S. Pat. No. 3,152,162; modified polyisocyanates containing urethane groups of the type described, for example, in U.S. Pat. Nos. 3,394,164 and 3,644,457; modified polyisocyanates containing allophanate groups of the type described, for example, in GB 994,890, BE 761,616, and NL 7,102,524; modified polyisocyanates containing isocyanurate groups of the type described, for example, in U.S. Pat. No. 3,002,973, German Patentschriften 1,022,789, 1,222,067 and 1,027,394, and German Offenlegungsschriften 1,919,034 and 2,004,048; modified polyisocyanates containing urea groups of the type described in German Patentschrift 1,230,778; polyisocyanates containing biuret groups of the type described, for example, in German Patentschrift 1,101,394, U.S. Pat. Nos. 3,124,605 and 3,201,372, and in GB 889,050; polyisocyanates obtained by telomerization reactions of the type described, for example, in U.S. Pat. No. 3,654,106; polyisocyanates containing ester groups of the type described, for example, in GB 965,474 and GB 1,072,956, in U.S. Pat. No. 3,567,763, and in German Patentschrift 1,231,688; reaction products of the above-mentioned isocyanates with acetals as described in German Patentschrift 1,072,385; and polyisocyanates containing polymeric fatty acid groups of the type described in U.S. Pat. No. 3,455,883. It is also possible to use the isocyanate-containing distillation residues accumulating in the production of isocyanates on a commercial scale, optionally in solution in one or more of the polyisocyanates mentioned above. Those skilled in the art will recognize that it is also possible to use mixtures of the polyisocyanates described above.

Isocyanate-terminated prepolymers may also be employed in the preparation of the polyurethanes of the present composite. Prepolymers may be prepared by reacting an excess of organic polyisocyanate or mixtures thereof with a minor amount of an active hydrogen-containing compound as determined by the well-known Zerewitinoff test, as described by Kohler in Journal of the American Chemical Society, 49, 3181(1927). These compounds and their methods of preparation are well known to those skilled in the art. The use of any one specific active hydrogen compound is not critical; any such compound can be employed in the practice of the present invention.

Although any isocyanate-reactive compound may be used to produce the polyurethanes of the inventive composite, polyether polyols are preferred as isocyanate-reactive components. Suitable methods for preparing polyether polyols are known and are described, for example, in EP-A 283 148, U.S. Pat. Nos. 3,278,457; 3,427,256; 3,829,505; 4,472,560; 3,278,458; 3,427,334; 3,941,849; 4,721,818; 3,278,459; 3,427,335; and 4,355,188.

Suitable polyether polyols may be used such as those resulting from the polymerization of a polyhydric alcohol and an alkylene oxide. Examples of such alcohols include ethylene glycol, propylene glycol, trimethylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, glycerol, 1,1,1-trimethylolpropane, 1,1,1-trimethylolethane, or 1,2,6-hexanetriol. Any suitable alkylene oxide may be used such as ethylene oxide, propylene oxide, butylene oxide, amylene oxide, and mixtures of these oxides. Polyoxyalkylene polyether polyols may be prepared from other starting materials such as tetrahydrofuran and alkylene oxide-tetrahydrofuran mixtures, epihalohydrins such as epichlorohydrin, as well as aralkylene oxides such as styrene oxide. The polyoxyalkylene polyether polyols may have either primary or secondary hydroxyl groups. Included among the polyether polyols are polyoxyethylene glycol, polyoxypropylene glycol, polyoxybutylene glycol, polytetramethylene glycol, block copolymers, for example, combinations of polyoxypropylene and polyoxyethylene glycols, poly-1,2-oxybutylene and polyoxyethylene glycols and copolymer glycols prepared from blends or sequential addition of two or more alkylene oxides. The polyoxyalkylene polyether polyols may be prepared by any known process.

Blowing agents which can be included are compounds with a chemical or physical action which are known to produce foamed products. Water is a particularly preferred example of a chemical blowing agent. Examples of physical blowing agents include inert (cyclo)aliphatic hydrocarbons having from 4 to 8 carbon atoms, which evaporate under the conditions of polyurethane formation. The amount of blowing agents used is guided by the target density of the foams.

As catalysts for polyurethane formation, it is possible to use those compounds which accelerate the reaction of the isocyanate with the isocyanate-reactive component. Suitable catalysts for use in the present invention include tertiary amines and/or organometallic compounds. Examples of compounds include the following: triethylenediamine, aminoalkyl- and/or aminophenyl-imidazoles, e.g. 4-chloro-2,5-dimethyl-1-(N-methylaminoethyl)imidazole, 2-aminopropyl-4,5-dimethoxy-1-methylimidazole, 1-aminopropyl-2,4,5-tributyl-imidazole, 1-aminoethyl-4-hexylimidazole, 1-aminobutyl-2,5-dimethylimidazole, 1-(3-aminopropyl)-2-ethyl-4-methylimidazole, 1-(3-aminopropyl)imidazole and/or 1-(3-aminopropyl)-2-methylimidazole, tin(II) salts of organic carboxylic acids, examples being tin(II) diacetate, tin(II) dioctoate, tin(II) diethylhexoate, and tin(II) dilaurate, and dialkyltin(IV) salts of organic carboxylic acids, examples being dibutyltin diacetate, dibutyltin dilaurate, dibutyltin maleate and dioctyltin diacetate.

The polyurethane forming reaction may take place, if desired, in the presence of auxiliaries and/or additives, such as cell regulators, release agents, pigments, surface-active compounds and/or stabilizers to counter oxidative, thermal or microbial degradation or aging.

The load-bearing composite panels of the invention may preferably be produced by reaction injection molding (RIM) techniques, which are known to those skilled in the art. The mixture of the long fiber reinforced polyurethane producing components with the fibers is preferably accomplished according to the long fiber injection (LFI) process.

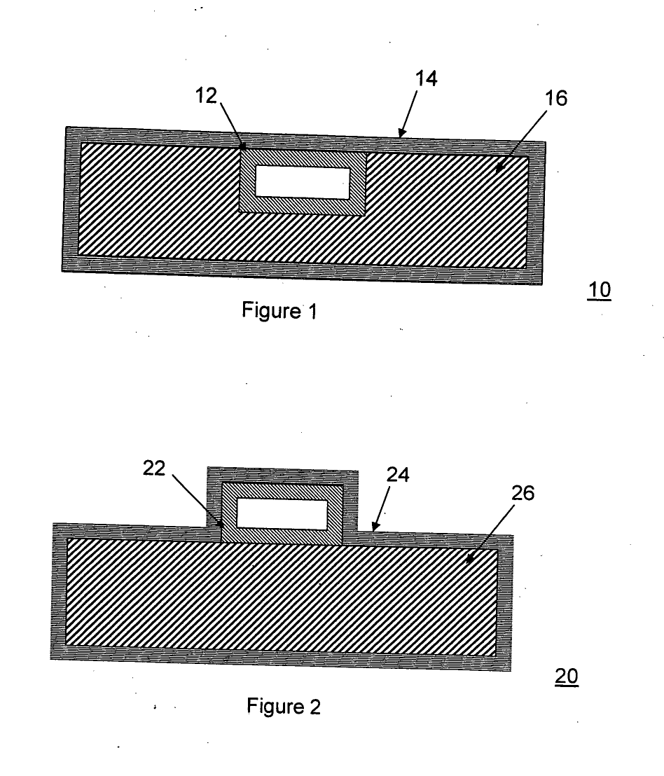

FIG. 1 shows a cross section taken through an embodiment of the load-bearing composite panel 10 of the present invention. The load-bearing composite panel 10 has hollow load-bearing member 12 surrounded by a polyurethane sandwich composite 16. The entire assemblage is encased in long fiber reinforced polyurethane 14 to form the load-bearing composite panel 10.

FIG. 2 depicts a cross section taken through another embodiment of the inventive load-bearing composite panel 20. The load-bearing composite panel 20 has hollow load-bearing member 22 abutting (contacting) a structural polyurethane sandwich composite 26. The entire assemblage is enclosed in long fiber reinforced polyurethane 24 to form the load-bearing composite panel 20.

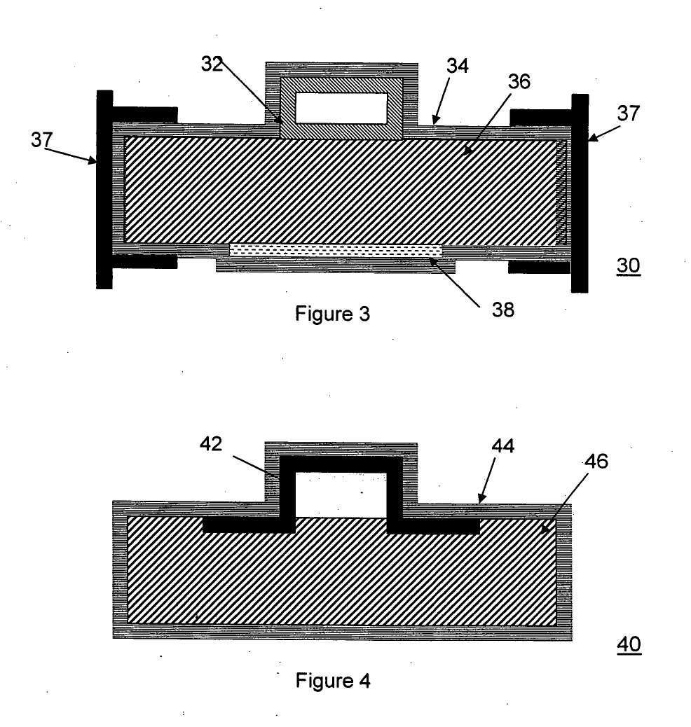

FIG. 3 illustrates a cross section taken through an embodiment of the load-bearing composite panel 30 of the present invention which is mounted in brackets. The load-bearing composite panel 30 has hollow load-bearing member 32 abutting (contacting) a structural polyurethane sandwich composite 36. A second, solid load-bearing member 38, in this case made of a different material than load bearing member 32, also abuts (contacts) the structural polyurethane sandwich composite 36. The entire assemblage is surrounded by long fiber reinforced polyurethane 34 to form the load-bearing composite panel 30 which is shown seated in brackets 37.

FIG. 4 provides a cross section taken through another embodiment of the inventive load-bearing composite panel 40. The load-bearing composite panel 40 has a load-bearing member 42 made from a metal stamping abutting a structural polyurethane sandwich composite 46. The entire assemblage is encapsulated in long fiber reinforced polyurethane 44 to form the load-bearing composite panel 40.

As will be appreciated by those skilled in the art, the composite panels of present invention encompass a variety of arrangements, configurations and combinations of load-bearing members within the structural polyurethane sandwich composite. For example, the structural polyurethane sandwich composite may encase a first load-bearing member and abut (contact) a second load-bearing member, or the structural polyurethane sandwich composite may enclose several load-bearing members and abut (contact) one or no second load-bearing member. The specific configuration and arrangement will be determined by the particular application for which the panel is intended.

The inventors herein contemplate that the load-bearing composite panels of the present invention may be incorporated into such items as automobile floor panels, walls for mobile homes, vehicle roof modules, truck beds, truck trailer floors and the like.

### EXAMPLES

The present invention is further illustrated, but is not to be limited, by the following examples. All quantities given in “parts” and “percents” are understood to be by weight, unless otherwise indicated. The following materials were used in preparing the composites of the examples:
Polyol A a sucrose-based polyether polyol having an OH number of 365-395;
Polyol B an amine-initiated propylene oxide-extended hydroxyl-terminated triol having a weight average molecular weight of 240;
Polyol C an ethylene diamine-based polyether polyol having an OH number of 600-660;
Polyol D a polypropylene oxide-based triol having a weight average molecular weight of 160;
Polyol E a polyester polyol containing oleic acid, adipic acid and pentaerythritol having an OH number of 51;
Catalyst a 62/38 weight percent blend of glycol and potassium acetate, respectively;
Release agent the reaction product of adipic acid, pentaerythritol, and oleic acid, having an acid number of less than 15 and a hydroxyl number of less than 15;
Pigment black pigment available as DR-2205 from Plasticolors, Inc.;
Isocyanate A a polymeric diphenylmethane diisocyanate having an NCO group content of about 31.5%, a functionality of about 2.8, and a viscosity of about 196 mPa·s at 25° C.; and
Isocyanate B an isocyanate-terminated prepolymer made by combining 90 parts Isocyanate A with 10 parts Polyol E, and having an NCO group content of about 28.5%.
   Structural Polyurethane Sandwich Composite

Polyurethane A was produced by reacting Isocyanate B at a ratio of isocyanate to polyol of 0.1.39:1.00 with the following polyol blend:

| Component | Parts |
|---|---|
| Polyol A | 53.75 |
| Polyol B | 35.75 |
| Fatty Acid | 5.0 |
| Catalyst | 0.5 |
| Pigment | 5.0 |

Structural polyurethane sandwich composite plaques were produced by wrapping a piece of paper honeycomb in glass mat. The thickness of the honeycomb used can be determined by the thickness of the part required. The amount or weight of glass mat used can vary as well depending upon the strength characteristics desired. In most cases, the glass weight will vary from 225 g/m² to 1200 g/m².

The honeycomb and glass mat sandwich was picked up by a robotic gripper and transported to a spray booth where Polyurethane A was applied to both sides of the packet in amounts equal to the weight of glass on either side of the packet. Upon completion of spraying, the packet was dropped into a heated mold (200-230° F.) where it was compressed into its final shape.

Polyurethane B

Isocyanate A was reacted at a ratio of isocyanate to polyol of 1.72:1.00 with the following polyol blend:

| Component | Parts |
|---|---|
| Polyol B | 40 |
| Polyol C | 31 |
| Polyol D | 17 |
| Quaternary amine salt | 4 |
| Release agent | 6 |
| Pigment | 2 |

Composite

An inventive composite (24 in.×24 in.×31 mm) was produced from steel tubing, structural polyurethane sandwich composite plaques and Polyurethane B. To produce a composite panel, the following five pieces were arranged in the mold:
1) Structural polyurethane sandwich composite (5 in.×24 in.×1 in.);
2) Steel tubing (2 in.×24 in.×1 in.);
3) Structural polyurethane sandwich composite (10 in.×24 in.×1 in.);
4) Steel tubing (2 in.×24 in.×1 in.); and
5) Structural polyurethane sandwich composite (5 in.×24 in.×1 in.).

The inventive composite panel was produced using long fiber technology (LFT), in which lengths of glass fiber were chopped and injected simultaneously with Polyurethane B into a heated mold at 150-175° F. After injection, the mold was closed and the part was cured. The panel was thus coated on one side with Polyurethane B. The panel was removed from the mold, trimmed, and reinserted in the mold so that the second side could be coated using the LFT process.

The inventive composite panels showed substantially increased buckling strength and bending stiffness over what was predicted for the individual components. The axial buckling strength was increased from two to five times that of the unencapsulated elements. Although not wishing to be bound by any theory, the inventors herein speculate that the chopped glass/polyurethane mixture of the long fiber reinforced polyurethane acted as a kind of “glue” which held all of the dissimilar materials together and adhered the fibers to the component parts. This, in turn, produced a synergistic effect which resulted in the increased performance of the composite panel.

Four-point bending tests were performed on the structural polyurethane sandwich composite coated using LFT and Polyurethane B and the calculated stiffness results are presented in the table below. The sandwich composite alone (control) exhibited excellent stiffness. The addition of a thin layer of long fiber reinforced polyurethane containing 20 wt. % glass fibers produced a 63% increase in the bending stiffness of the sample. The increase in stiffness was commensurately greater (122%) when the loading of glass fibers was increased to 45 wt. % in the thin layer applied over the sandwich composite.

Stiffness

| Sample | (lb_{f}/in.) | Percent increase |
|---|---|---|
| PU sandwich composite | 1565 | — |
| +20 wt, % LFT | 2550 | 63 |
| +45 wt. % LFT | 3470 | 122 |

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed:

1. A load-bearing composite panel comprising:
a long fiber reinforced polyurethane surrounding an assembly comprising one or more load-bearing members and a structural polyurethane sandwich composite.

2. The load-bearing composite panel according to claim 1, wherein the long fiber reinforced polyurethane comprises at least one fiber chosen from glass, flax, jute, sisal, polyamide, polyester, carbon and polyurethane fibers.

3. The load-bearing composite panel according to claim 1, wherein the long fiber reinforced polyurethane comprises fibers having a length of more than about 3 mm.

4. The load-bearing composite panel according to claim 1, wherein the long fiber reinforced polyurethane comprises fibers having a length of more than about 10 mm.

5. The load-bearing composite panel according to claim 1, wherein the long fiber reinforced polyurethane comprises fibers having a length of from about 12 mm to about 75 mm.

6. The load-bearing composite panel according to claim 1, wherein the long fiber reinforced polyurethane comprises from about 5 to about 75 wt. %, based on the weight of the long fiber reinforced polyurethane, of long fibers.

7. The load-bearing composite panel according to claim 1, wherein the long fiber reinforced polyurethane comprises from about 10 to about 60 wt. %, based on the weight of the long fiber reinforced polyurethane, of long fibers.

8. The load-bearing composite panel according to claim 1, wherein the long fiber reinforced polyurethane comprises from about 20 to about 50 wt. %, based on the weight of the long fiber reinforced polyurethane, of long fibers.

9. The load-bearing composite panel according to claim 1, wherein the long fiber reinforced polyurethane comprises the reaction product of one or more isocyanates and one or more isocyanate-reactive components.

10. The load-bearing composite panel according to claim 9, wherein the isocyanate is chosen from ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3- and -1,4-diisocyanate, 1-isocyanato-3,3,5-trimethyl-5-isocyanatomethylcyclohexane, (isophorone diisocyanate), 2,4- and 2,6-hexahydrotoluene diisocyanate, dicyclohexylmethane-4,4′-diisocyanate (hydrogenated MDI, or HMDI), 1,3- and 1,4-phenylene diisocyanate, 2,4- and 2,6-toluene diisocyanate (TDI), diphenylmethane-2,4′- and/or -4,4′-diisocyanate (MDI), naphthylene-1,5-diisocyanate, triphenylmethane-4,4′,4″-triisocyanate, polyphenyl-polymethylene-polyisocyanates, norbornane diisocyanates, m- and p-isocyanatophenyl sulfonylisocyanates, perchlorinated aryl polyisocyanates carbodiimide-modified polyisocyanates, urethane-modified polyisocyanates, allophanate-modified polyisocyanates, isocyanurate-modified polyisocyanates, urea-modified polyisocyanates, biuret-containing polyisocyanates and isocyanate-terminated prepolymers.

11. The load-bearing composite panel according to claim 9, wherein the isocyanate-reactive component is chosen from polyether polyols, polyester polyols, polythioether polyols, polyesteramides, hydroxyl-containing polyacetals, hydroxyl-containing aliphatic polycarbonates and mixtures thereof.

12. The load-bearing composite panel according to claim 1, wherein the load-bearing member comprises a material chosen from metal, plastic and wood.

13. The load-bearing composite panel according to claim 1, wherein the load-bearing member comprises a metal chosen from steel and aluminum.

14. The load-bearing composite panel according to claim 1, wherein the load-bearing member is chosen from tubes, rods, beams, slabs, plates, planks and stampings.

15. The load-bearing composite panel according to claim 1, wherein the structural polyurethane sandwich composite comprises the reaction product of one or more isocyanates and one or more isocyanate-reactive components.

16. The load-bearing composite panel according to claim 15, wherein the isocyanate is chosen from ethylene diisocyanate, 1,4-tetramethylene diisocyanate, 1,6-hexamethylene diisocyanate, 1,12-dodecane-diisocyanate, cyclobutane-1,3-diisocyanate, cyclohexane-1,3- and -1,4-diisocyanate, 1-isocyanato-3,3,5-trimethyl-5-isocyanatomethylcyclohexane, (isophorone diisocyanate), 2,4- and 2,6-hexahydrotoluene diisocyanate, dicyclohexylmethane-4,4′-diisocyanate (hydrogenated MDI, or HMDI), 1,3- and 1,4-phenylene diisocyanate, 2,4- and 2,6-toluene diisocyanate (TDI), diphenylmethane-2,4′- and/or -4,4′-diisocyanate (MDI), naphthylene-1,5-diisocyanate, triphenylmethane-4,4′,4″-triisocyanate, polyphenyl-polymethylene-polyisocyanates, norbornane diisocyanates, m- and p-isocyanatophenyl sulfonylisocyanates, perchlorinated aryl polyisocyanates carbodiimide-modified polyisocyanates, urethane-modified polyisocyanates, allophanate-modified polyisocyanates, isocyanurate-modified polyisocyanates, urea-modified polyisocyanates, biuret-containing polyisocyanates and isocyanate-terminated prepolymers.

17. The load-bearing composite panel according to claim 15, wherein the isocyanate-reactive component is chosen from polyether polyols, polyester polyols, polythioether polyols, polyesteramides, hydroxyl-containing polyacetals, hydroxyl-containing aliphatic polycarbonates and mixtures thereof.

18. The load-bearing composite panel according to claim 1, wherein the structural polyurethane sandwich composite comprises:
at least one glass mat;
a structural polyurethane foam; and
a paper honeycomb.

19. The load-bearing composite panel according to claim 1, wherein the structural polyurethane sandwich composite encases the one or more load-bearing members.

20. The load-bearing composite panel according to claim 1, wherein the structural polyurethane sandwich composite contacts the one or more load-bearing members.

21. In a process for producing one of an automobile floor panel, a mobile home wall, a roof module, a truck floor, a truck floor and a truck trailer floor, the improvement comprising including the load-bearing composite panel according to claim 1.

22. A process for making a load-bearing composite panel comprising:
surrounding with a long fiber reinforced polyurethane an assembly comprising one or more load-bearing members and a structural polyurethane sandwich composite.

23. The process according to claim 22, wherein the long fiber reinforced polyurethane comprises at least one fiber chosen from glass, flax, jute, sisal, polyamide, polyester, carbon and polyurethane fibers.

24. The process according to claim 22, wherein the long fiber reinforced polyurethane comprises fibers having a length of more than about 3 mm.

25. The process according to claim 22, wherein the long fiber reinforced polyurethane comprises fibers having a length of more than about 10 mm.

26. The process according to claim 22, wherein the long fiber reinforced polyurethane comprises fibers having a length of from about 12 mm to about 75 cm.

27. The process according to claim 22, wherein the long fiber reinforced polyurethane comprises from about 5 to about 75 wt. %, based on the weight of the long fiber reinforced polyurethane, of long fibers.

28. The process according to claim 22, wherein the long fiber reinforced polyurethane comprises from about 10 to about 60 wt. %, based on the weight of the long fiber reinforced polyurethane, of long fibers.

29. The process according to claim 22, wherein the long fiber reinforced polyurethane comprises from about 20 to about 50 wt. %, based on the weight of the long fiber reinforced polyurethane, of long fibers.

30. The process according to claim 22, wherein the long fiber reinforced polyurethane comprises the reaction product of one or more isocyanates and one or more isocyanate-reactive components.

31. The process according to claim 30, wherein the isocyanate is chosen from ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3- and -1,4-diisocyanate, 1-isocyanato-3,3,5-trimethyl-5-isocyanatomethylcyclohexane, (isophorone diisocyanate), 2,4- and 2,6-hexahydrotoluene diisocyanate, dicyclohexylmethane-4,4′-diisocyanate (hydrogenated MDI, or HMDI), 1,3- and 1,4-phenylene diisocyanate, 2,4- and 2,6-toluene diisocyanate (TDI), diphenylmethane-2,4′- and/or -4,4′-diisocyanate (MDI), naphthylene-1,5-diisocyanate, triphenylmethane-4,4′,4″-triisocyanate, polyphenyl-polymethylene-polyisocyanates, norbornane diisocyanates, m- and p-isocyanatophenyl sulfonylisocyanates, perchlorinated aryl polyisocyanates carbodiimide-modified polyisocyanates, urethane-modified polyisocyanates, allophanate-modified polyisocyanates, isocyanurate-modified polyisocyanates, urea-modified polyisocyanates, biuret-containing polyisocyanates and isocyanate-terminated prepolymers.

32. The process according to claim 30, wherein the isocyanate-reactive component is chosen from polyether polyols, polyester polyols, polythioether polyols, polyesteramides, hydroxyl-containing polyacetals, hydroxyl-containing aliphatic polycarbonates and mixtures thereof.

33. The process according to claim 22, wherein the load-bearing member comprises a material chosen from metal, plastic and wood.

34. The process according to claim 22, wherein the load-bearing member comprises a metal chosen from steel and aluminum.

35. The process according to claim 22, wherein the load-bearing member is chosen from tubes, rods, beams, slabs, plates, planks and stampings.

36. The process according to claim 22, wherein the structural polyurethane sandwich composite comprises the reaction product of one or more isocyanates and one or more isocyanate-reactive components.

37. The process according to claim 36, wherein the isocyanate is chosen from ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3- and -1,4-diisocyanate, 1-isocyanato-3,3,5-trimethyl-5-isocyanatomethylcyclohexane, (isophorone diisocyanate), 2,4- and 2,6-hexahydrotoluene diisocyanate, dicyclohexylmethane-4,4′-diisocyanate (hydrogenated MDI, or HMDI), 1,3- and 1,4-phenylene diisocyanate, 2,4- and 2,6-toluene diisocyanate (TDI), diphenylmethane-2,4′- and/or -4,4′-diisocyanate (MDI), naphthylene-1,5-diisocyanate, triphenylmethane-4,4′,4″-triisocyanate, polyphenyl-polymethylene-polyisocyanates, norbornane diisocyanates, m- and p-isocyanatophenyl sulfonylisocyanates, perchlorinated aryl polyisocyanates carbodiimide-modified polyisocyanates, urethane-modified polyisocyanates, allophanate-modified polyisocyanates, isocyanurate-modified polyisocyanates, urea-modified polyisocyanates, biuret-containing polyisocyanates and isocyanate-terminated prepolymers.

38. The process according to claim 36, wherein the isocyanate-reactive component is chosen from polyether polyols, polyester polyols, polythioether polyols, polyesteramides, hydroxyl-containing polyacetals, hydroxyl-containing aliphatic polycarbonates and mixtures thereof.

39. The process according to claim 22, wherein the structural polyurethane sandwich composite comprises:
at least one glass mat;
a structural polyurethane foam; and
a paper honeycomb.

40. The process according to claim 22, wherein the structural polyurethane sandwich composite surrounds the one or more load-bearing members.

41. The process according to claim 22, wherein the structural polyurethane sandwich composite contacts the one or more load-bearing members.

42. In a process for producing one of an automobile floor panel, a mobile home wall, a roof module, a truck floor, a truck floor and a truck trailer floor, the improvement comprising including the load-bearing composite panel made by the process according to claim 22.
